(19) United States
(12) Patent Application Publication
(10) Pub. No.: US 2026/0181714 A1
(43) Pub. Date: Jun. 25, 2026

(54) SUPPRESS N1N2 MESSAGE TRANSFER FOR FAILURE NOTIFICATION

(71) Applicant: Telefonaktiebolaget LM Ericsson (publ), Stockholm (SE)

(72) Inventors: Jinyang XIE, Shanghai (CN); Yunjie LU, Shanghai (CN); Susana Fernandez ALONSO, Madrid (ES); Hong ZHANG, Goeteborg (SE)

(73) Assignee: Telefonaktiebolaget LM Ericsson (publ), Stockholm (SE)

(21) Appl. No.: 19/123,833

(22) PCT Filed: Aug. 21, 2023
(86) PCT No.: PCT/CN2023/113988

§ 371 Date: Apr. 24, 2025

(30) Foreign Application Priority Data
Oct. 30, 2022 (WO) PCT/CN2022/128466

(51) Int. Cl. H04W 76/12; H04W 76/18; H04W 76/27

(52) U.S. Cl. CPC H04W 76/12; H04W 76/18; H04W 76/27

(57) ABSTRACT

The embodiments herein relate to suppressing N1N2 message transfer for failure notification. In some embodiments, a method is performed by a first network function implementing an Access and Mobility Management Function (AMF). The method may include the step of paging a User Equipment (UE). The method may further include the step of transmitting, to a second network function implementing a network function consumer, a failure notification message including a first parameter indicating a retry-after time, in response to a failure in the paging. A transfer of message from the second network function to the first network function may be suppressed during the retry-after time. With the embodiments, by defining a retry-after timer in the failure notification, the unnecessary signal exchange between the network function service consumer and the AMF before the timeout of the retry-after timer may be reduced.

### CROSS REFERENCE TO RELATED APPLICATION

This application claims priority of PCT Application Serial Number PCT/CN2022/128466 filed on Oct. 30, 2022 with title of “SUPPRESS N1N2 MESSAGE TRANSFER FOR FAILURE NOTIFICATION”, the entire contents of which are incorporated herein by reference.

### TECHNICAL FIELD

The embodiments herein relate generally to the field of mobile communication, and more particularly, the embodiments herein relate to suppressing N1N2 message transfer for failure notification.

### BACKGROUND

FIG. 1 is a schematic block diagram showing example architecture 100 for 5G network architecture at non-roaming scenario. In the 5G network, the network triggered service request procedure is used when the network initiates a signaling to a User Equipment (UE). FIG. 2 is a schematic signaling chart showing the messages in an example network triggered service request procedure. As shown in FIG. 2, the Session Management Function (SMF) 102 may transfer N1 and/or N2 message to the Access and Mobility Management Function (AMF) 101, for example when there is downlink data to be sent.

### SUMMARY

It is noted that, the current network triggered service request procedure may cause wasted unnecessary resources, due to some unnecessary N1N2 message transfers.

The embodiments herein propose methods, network functions, computer readable mediums and computer program products for suppressing N1N2 message transfer for failure notification.

In some embodiments, there proposes a method performed by a first network function implementing an AMF. The method may comprise the step of paging to a UE. The method may further comprise the step of transmitting, to a second network function implementing a network function consumer, a failure notification message including a first parameter indicating a retry-after time, in response to a failure in the paging. A transfer of message from the second network function to the first network function may be suppressed during the retry-after time.

In an embodiment, the failure notification message may be N1N2 message transfer failure notification message.

In an embodiment, the second network function may implement a SMF, Short Message Service Function (SMSF), Location Management Function (LMF), Policy Control Function (PCF), Gateway Mobile Location Center (GMLC), Network Exposure Function (NEF) or Unified Data Management (UDM).

In an embodiment, the failure notification message may further include a second parameter indicating a failure cause.

In an embodiment, the failure cause may be that the UE is not reachable or there is an ongoing procedure.

In an embodiment, the ongoing procedure may be an ongoing registration procedure or an ongoing handover procedure.

In an embodiment, N1N2 message transfer request message may be suppressed during the retry-after time.

In some embodiments, there proposes a method performed by a second network function implementing a network function consumer. The method may comprise the step of receiving, from a first network function implementing an AMF, a failure notification message including a first parameter indicating a retry-after time. The failure notification message may be transmitted in response to a failure in a paging from the first network function to a UE. In an embodiment, the method may further comprise the step of starting a retry-after timer, to suppress a transfer of message from the second network function to the first network function during the retry-after time.

In an embodiment, the failure notification message may be N1N2 message transfer failure notification message.

In an embodiment, the second network function may implement a SMF, SMSF, LMF, PCF, GMLC, NEF or UDM.

In an embodiment, the failure notification message may further include a second parameter indicating a failure cause.

In an embodiment, the failure cause may be that the UE is not reachable or there is an ongoing procedure.

In an embodiment, the ongoing procedure may be an ongoing registration procedure or an ongoing handover procedure.

In an embodiment, N1N2 message transfer request message may be suppressed during the retry-after time.

In an embodiment, the method may further comprise the step of receiving a data transfer request from a third network function implementing a User Plane Function (UPF).

In an embodiment, the method may further comprise the step of buffering the data transfer request during the retry-after time; and handling the data transfer request after the retry-after time.

In an embodiment, the method may further comprise the step of receiving a data transfer request from a third network function implementing a UPF. In an embodiment, the method may further comprise the step of stopping a transfer of message to the first network function; and informing the third network function to drop a buffer.

In an embodiment, the data transfer request may be a Downlink Data Notification (DDN) request.

In an embodiment, the method may further comprise the step of receiving a control plane request from a fourth network function implementing a PCF. In an embodiment, the method may further comprise the step of buffering the control plane request during the retry-after time; and handling the control plane request after the retry-after time.

In an embodiment, the method may further comprise the step of receiving a control plane request from a fourth network function implementing a PCF. In an embodiment, the method may further comprise the step of stopping handling the control plane request; and transmitting, to the fourth network function, an enforcement failure message.

In an embodiment, the enforcement failure message may further include at least one of a third parameter indicating a failure code and a fourth parameter indicating a rule status.

In an embodiment, the control plane request may be a session management policy control update notify request or a session management policy control update response.

In an embodiment, the session management policy may be a Policy and Charging Control (PCC) rule.

In some embodiments, there proposes a network function. In an embodiment, the network function may comprise at least one processor; and a non-transitory computer readable medium coupled to the at least one processor. The non-transitory computer readable medium may store instructions executable by the at least one processor, whereby the at least one processor may be configured to perform any of the above methods. In an embodiment, the network function may be configured as either the first network function or the second network function.

In some embodiments, there proposes a computer readable medium comprising computer readable code, which when run on an apparatus, may cause the apparatus to perform any of the above methods.

In some embodiments, there proposes a computer program product comprising computer readable code, which when run on an apparatus, may cause the apparatus to perform any of the above methods.

With the embodiments, by defining a retry-after timer in N1N2Transfer failure notification, the unnecessary signal exchange between the NF service consumer and the AMF before the timeout of the retry-after timer may be reduced.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture for 5G network architecture at non-roaming scenario;

FIG. 2 is a schematic signaling chart showing the messages in an example network triggered service request procedure;

FIG. 3 is a schematic signaling chart showing the messages in an example N1N2 transfer failure notification procedure;

FIG. 4 is a schematic signaling chart showing the messages in an example message throttle sequence flow;

FIG. 5 is a schematic signaling chart showing the messages in an example procedure for suppressing N1N2 message transfer for failure notification, according to the embodiments herein;

FIG. 6 is a schematic signaling chart showing the messages in another example procedure for suppressing N1N2 message transfer for failure notification, according to the embodiments herein;

FIG. 7 is a schematic flow chart showing an example method in the first network function, according to the embodiments herein;

FIG. 8 is a schematic flow chart showing an example method in the second network function, according to the embodiments herein;

FIG. 9 is a schematic block diagram showing an example first network function, according to the embodiments herein;

FIG. 10 is a schematic block diagram showing an example second network function, according to the embodiments herein; and

FIG. 11 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

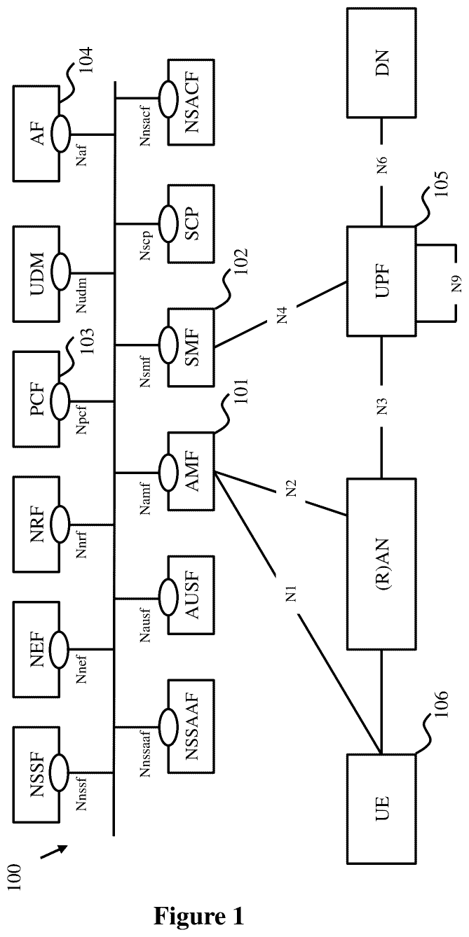

The embodiments may be implemented in the example architecture 100 as shown in FIG. 1.

In an embodiment, the example architecture 100 may be configured in an Over The Top (OTT) scenario. The OTT connection may be transparent in the sense that the participating communication devices through which the OTT connection passes are unaware of routing of uplink and downlink communications. For example, a base station may not or needs not to be informed about the past routing of an incoming downlink communication with data originating from the network functions (such as the AMF 101, SMF 102, PCF 103, Application Function (AF) 104, or UPF 105) in the core network to be forwarded (e.g., handed over) to a connected UE 106. Similarly, the base station needs not to be aware of the future routing of an outgoing uplink communication originating from the UE towards the network functions (such as the AMF 101, SMF 102, PCF 103, AF 104, or UPF 105) in the core network.

It should also be understood that, a network function (such as the AMF 101, SMF 102, PCF 103, AF 104, or UPF 105 in FIG. 1) can be implemented either as a network element on a dedicated hardware, as a software instance running on a dedicated hardware, or as a virtualized function instantiated on an appropriate platform, e.g., on a cloud infrastructure.

### Network Triggered Service Request

Referring to clause 4.2.3.3 of 3GPP TS23.502, the network triggered service request procedure may be used when the network initiates a signaling (e.g. N1 signaling to UE, mobile-terminated Short Messaging Service (SMS), user plane connection activation for Packet Data Unit (PDU) session(s) to deliver mobile-terminated user data) to the UE 106.

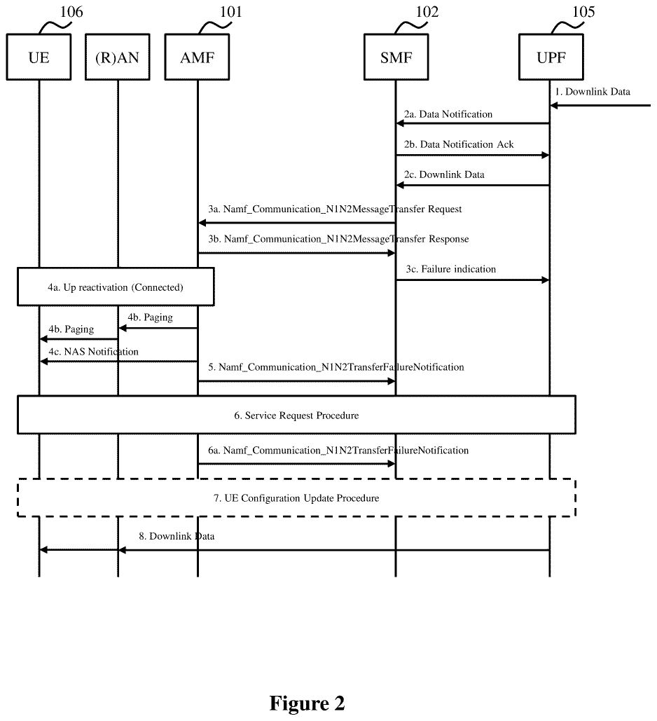

Note that, the procedure may also be triggered by SMSF, PCF, LMF, Gateway Mobile Location Center (GMLC), Network Exposure Function (NEF) or Unified Data Management (UDM). In this case, the SMF 102 in the FIG. 2 may be replaced by the respective network function (NF).

If the UE 106 is in a Connection Management (CM) IDLE state or a CM-CONNECTED state in 3GPP access, the network may initiate a network triggered service request procedure. If the UE 106 is in the CM-IDLE state, and asynchronous type communication is not activated, the network may send a paging request to (R)AN/UE (RAN: Radio Access Network). The paging request may trigger a UE triggered service request procedure in the UE 106. If the asynchronous type communication is activated, the network may store the received message and forward the message to the (R)AN and/or the UE 106 (i.e. synchronizing the context with the (R)AN and/or the UE) when the UE 106 enters to the CM-CONNECTED state.

The network triggered service request procedure in FIG. 2 mainly includes the following messages or steps:
Step 3a. [conditional] the SMF 102 to the AMF 101: Namf_Communication_N1N2MessageTransfer (Subscription Permanent Identifier (SUPI), PDU session ID, N1 Session Management (SM) container (SM message), N2 session management information (QoS flow identifier(s), QoS profile(s), core network N3 tunnel information, Single Network Slice Selection Assistance information (S-NSSAI)), area of validity for N2 SM information, Address Resolution Protocol (ARP), paging policy indicator, 5G QoS Identifier (5QI), N1N2TransferFailure notification target address, extended buffering support), or NF to the AMF 101: Namf_Communication_N1N2MessageTransfer (SUPI, N1 message).
Step 3b. [conditional] The AMF 101 responds to the SMF 102.

If the UE 106 is in the CM-IDLE state at the AMF 101, and the AMF 101 is able to page the UE 106; the AMF 101 may send a Namf_Communication_N1N2MessageTransfer response to the SMF 102 immediately to indicate to the SMF 102 that the AMF 101 is attempting to reach UE 106 and the N2 SM information provided in step 3a may be ignored by the AMF 101 once the UE 106 is reachable and the SMF 102 may be asked to provide the N2 SM information again.

While waiting for the UE 106 to respond to a previous paging request, if the AMF 101 receives an Namf_Communication_N1N2MessageTransfer request message with the same or a lower priority than the previous message triggering the paging, or if the AMF 101 has determined not to trigger additional paging requests for this UE 106 based on the local policy, the AMF 101 may reject the Namf_Communication_N1N2MessageTransfer request message.

If the UE 106 is in the CM-CONNECTED state at the AMF 101, then the AMF 101 may send a Namf_Communication_N1N2MessageTransfer response to the SMF 102 immediately to indicate that the N1/N2 message has been sent out.

If the UE 106 is in the CM-IDLE state, and the AMF 101 determines that the UE 106 is not reachable for paging, the AMF 101 shall send an Namf_Communication_N1N2MessageTransfer response to the NF from which the AMF 101 received the request message in step 3a to indicate that the UE 106 is not reachable, or the AMF 101 may perform the asynchronous type communication and store the UE context based on the received message, the AMF 101 shall send an Namf_Communication_N1N2MessageTransfer response to indicate that the asynchronous type communication is invoked. If the asynchronous type communication is invoked, the AMF 101 may initiate communication with the UE 106 and (R)AN when the UE 106 is reachable, for example when the UE 106 enters to the CM-CONNECTED state.

Upon reception of an Namf_Communication_N1N2MessageTransfer response with an indication that its request has been temporarily rejected, the SMF 102 shall start a locally configured guard timer and wait for any message to come from an AMF 101.

Upon reception of a message from an AMF 101, the SMF 102 shall re-invoke the Namf_Communication_N1N2MessageTransfer (with N2 SM information and/or N1 SM information) to the AMF 101 from which it received the message. Otherwise the SMF 102 may take the step 3c at expiry of the guard timer. If the SMF 102 decides that the control plane buffering applies, the SMF 102 shall request the UPF 105 to start to forward the downlink data PDU towards the SMF 102.
Step 5. [conditional] the AMF 101 to the SMF 102: Namf_Communication_N1N2Transfer failure notification.

The AMF 101 may supervise the paging procedure with a timer. If the AMF 101 receives no response, from the UE 106, to the paging request message, the AMF 101 may apply further paging according to any applicable paging strategy described in step 4b.

The AMF 101 may notify the SMF 102 by sending an Namf_Communications_N1N2MessageTransfer failure notification to the notification target address provided by the SMF 102 in step 3a if the UE 106 does not respond to paging, unless the AMF 101 is aware of an ongoing MM procedure that prevents the UE 106 from responding, i.e. the AMF 101 receives an N14 context request message indicating that the UE 106 performs registration procedure with another AMF.

### N1N2Transfer Failure Notification

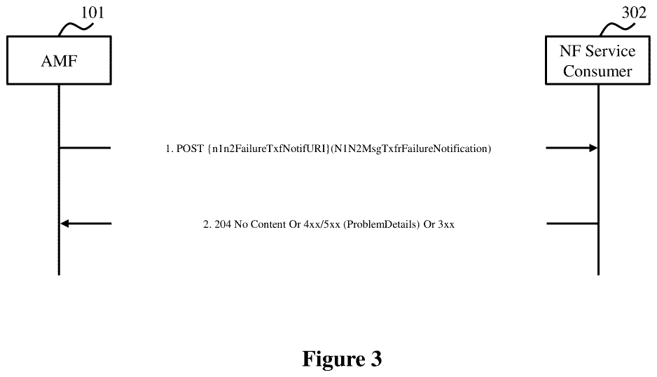

FIG. 3 is a schematic signaling chart showing the messages in an example N1N2 transfer failure notification procedure. The AMF 101 may use this notification to inform the NF service consumer 302 that initiated an earlier Namf_Communication_N1N2MessageTransfer, that the AMF 101 failed to deliver the N1 and/or N2 message. The HTTP POST method may be used on the notification callback URI provided by the NF service consumer 302 as specified in clause 5.2.2.3.1.2 of 3GPP TS29.518.

The N1N2 transfer failure notification in FIG. 3 may include the following messages or steps:
Step 1. If the NF service consumer 302 had provided a notification URI (see clause 5.2.2.3.1.2 of 3GPP TS29.518), the AMF 101 shall send a POST request to the NF service consumer 302 on that notification URI when the AMF 101 determines that:
   the paging or NAS notification has failed;
   the indicated non-3GPP PDU session is not allowed to move to 3GPP access;
   the UE 106 has rejected the paging as defined in 3GPP TS 23.501 clause 5.38.4;
   the delivery of the N1 message fails, e.g. in case the UE 106 is in RRC inactive and NG-RAN paging was not successful or in case an Xn or N2 handover is being triggered at the NG-RAN.

The AMF 101 shall include the N1N2MessageTransfer request resource URI returned earlier in the N1N2MessageTransfer response if any (see clause 5.2.2.3.1.2 of 3GPP TS29.518), otherwise a dummy URI (see clause 6.1.6.2.30 of 3GPP TS29.518), in the POST request body. The AMF 101 shall also include a N1/N2 message transfer cause information in the POST request body and set the value as specified in clause 6.1.5.6.3.1 of 3GPP TS29.518.

The NF service consumer 302 shall delete any stored representation of the N1N2MessageTransfer request resource URI upon receiving this notification.
Step 2. The NF service consumer 302 shall send a response with “204 No Content” status code.

On failure or redirection, one of the HTTP status codes together with the response body listed in Table 6.1.5.6.3.1-2 of 3GPP TS29.518 shall be returned.

### N1N2 Transfer Failure Notification

The notification standard methods (such as POST) may send an N1/N2 message transfer failure notification to the NF service consumer 302 (e.g., the SMF 102).

This method shall support the request data structures specified in table 6.1.5.6.3.1-1 of 3GPP TS29.518 (see the below table 1) and the response data structures and response codes specified in table 6.1.5.6.3.1-3 of 3GPP TS29.518.

TABLE 1
Data structures supported by the POST request body

| Data type | P | Cardinality | Description |
|---|---|---|---|
| N1N2MsgTxfrFail- | M | 1 | Representation of the N1/N2 message transfer failure notification. |
| ureNotification | | | The “cause” attribute shall be set to one of following cause value |
| | | | s (see clause 6.1.6.3.6 of 3GPP TS29.518): |
| | | | UE_NOT_RESPONDING |
| | | | UE_NOT_REACHABLE_FOR_SESSION |
| | | | TEMPORARY_REJECT_REGISTRATION_ONGOING |
| | | | TEMPORARY_REJECT_HANDOVER_ONGOING |
| | | | REJECTION_DUE_TO_PAGING_RESTRICTION |
| | | | AN_NOT_RESPONDING |
| | | | FAILURE_CAUSE_UNSPECIFIED |

Message Sequence Flow when UE is not Reachable

Based on the above network triggered service request procedure as specified in 3GPP TS23.502 and N1N2 transfer failure notification procedure as specified in 3GPP TS29.518, the following sequence flow describes the current sequence flow.

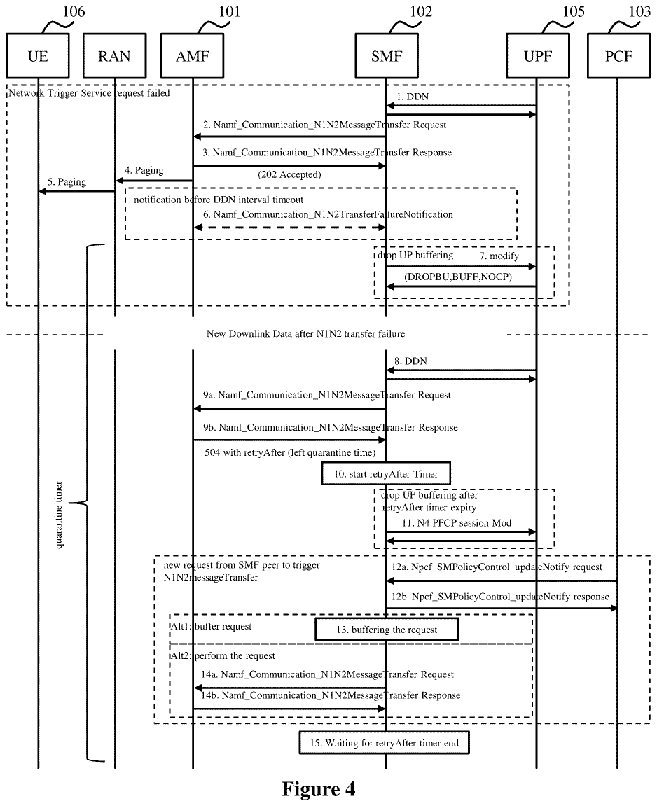

FIG. 4 is a schematic signaling chart showing the messages in an example message throttle sequence flow. The message throttle sequence flow in FIG. 4 may include the following messages or steps:
Step 1. When a UPF 105 receives downlink data for a PDU session and there is no AN tunnel information stored in the UPF 105 for the PDU Session, based on the instruction from the SMF 102, the UPF 105 may buffer the downlink data and send Downlink Data Notification (DDN) to the SMF 102.
Step 2. The SMF 102 may determine the AMF 101 and invoke the Namf_Communication_N1N2MessageTransfer to the AMF 101 including the PDU session ID of the PDU session.
Step 3. If the UE 106 is in CM-IDLE state at the AMF 101, and the AMF 101 is able to page the UE 106, the AMF 101 may send an Namf_Communication_N1N2MessageTransfer response to the SMF 102 immediately to indicate to the SMF 102 that the AMF 101 is attempting to reach the UE 106.
Step 4. The AMF 101 may send a paging message to NG-RAN node(s) via 3GPP access.
Step 5. The NG-RAN sends the paging message to the UE 106.
Step 6. The AMF 101 may notify the SMF 102 by sending an Namf_Communications_N1N2MessageTransfer failure notification to the notification target address provided by the SMF 102 in step 2 if the UE 106 does not respond to paging.
Step 7. The SMF 102 may inform the UPF 105 to drop the buffer.
Step 8. The UPF 105 may send the DDN to the SMF 102.
Step 9. The SMF 102 may determine the AMF 101 and invoke the Namf_Communication_N1N2MessageTransfer to the AMF 101. The AMF 101 may respond with the status code “504 Gateway Timeout”, if the UE 106 is currently unreachable (e.g., due to the UE 106 in Mobile Initiated Connection Only (MICO) mode, the UE 106 using extended idle mode Discontinuous Reception (DRX) or the UE 106 is only registered over Non-3GPP access and its state is CM-IDLE). The AMF 101 will set the application error as “UE_NOT_REACHABLE” and may include “retryAfter” (i.e., retry-after) timer if the AMF 101 requests the NF service consumer 302 to stop sending the N1/N2 message before timeout in POST response body.
Step 10. The SMF 102 may start the retry-after timer if the AMF requests the NF service consumer 302 to stop sending the N1/N2 message before timeout.
Step 11. The SMF 102 may inform the UPF 105 to drop the buffer.
Step 12. When the retry-after timer is running, the SMF 102 may receive the Session Management (SM) policy control update notification request from the PCF 103. The SMF 102 may acknowledge the notification.

There are two alternatives for the new NF request which is related to N1N2MessageTransfer:
Step 13. Alt1: The SMF 102 may buffer the request and handle the request after the retry-after timer is expired.
Step 14. Alt2: The SMF 102 may send the N1N2MessageTransfer if it has higher priority and the SMF 102 may handle the response accordantly.
Step 15. The SMF 102 may wait for the retry-after timer's expiry.

It is noted that there may be unnecessary signaling in the following situation. When the NF service consumer 302 initiates the Namf_Communications_N1N2MessageTransfer request to the AMF 101, the AMF 101 may respond with the status code “202 Accepted”, if paging is issued when the UE 106 is in CM-IDLE and reachable for 3GPP access, with a response body that carries a cause “ATTEMPTING_TO_REACH_UE”. But during the paging procedure, if there is an ongoing registration procedure, or if there is an ongoing Xn or N2 handover procedure, if the UE is currently unreachable, the AMF 101 may send N1N2Transfer failure notification to the NF service consumer 302.

In this situation, the AMF 101 can respond with the failure cause and optionally a timer indicating when the ongoing procedures will be completed or when the UE 106 could be reachable, then the NF service consumer 302 could stop sending the Namf_Communications_N1N2MessageTransfer request and reattempt the buffering request or send the new requests after the timer's expiry.

But with current 3GPP specifications the AMF 101 does not provide an estimate of the AMF 101, in the N1N2Transfer failure notification, on how long it will take before the AMF 101 considers the ongoing procedure(s) as completed or how long it will quarantine the UE 106 to reduce the paging and to save the RAN resources since the UE 106 is not reachable or other unspecified cause.

As there is no mechanism in the Namf_Communications_N1N2MessageTransfer failure notification to inform the NF service consumer 302 to stop sending the N1/N2 message, the NF service consumer 302 may initiate an Namf_Communication_N1N2MessageTransfer operation for the same UE even it receives the Namf_Communications_N1N2MessageTransfer failure notification from the AMF 101, as steps 8 to 11 in FIG. 4. After the AMF 101 receives the new Namf_Communication_N1N2MessageTransfer request, the AMF 101 may determine the current status of the AMF 101 and may respond with the 4xx or 5xx with the message body containing a N1N2MessageTransferError structure including:
a “ProblemDetails” structure with the “cause” attribute set to one of the application errors;
an “N1N2MsgTxfrErrDetail” structure with the “retryAfter” timer to request the NF service consumer to stop sending the N1/N2 message before timeout.

Based on the “retryAfter” timer in the response message body of the 4xx or 5xx, the NF service consumer 302 can suppress the subsequent procedures, as steps 12 to 14 in FIG. 4. But it may be too late, i.e., the suppressing could be happened earlier as steps 8 to 11 in FIG. 4, so that the network could have not wasted unnecessary resources, signaling would have been simplified, and new error situations could have been avoided.

In addition, it is noted that the N1/N2 message transfer failure cause does not cover the case that the UE is not reachable for paging.

In view of the above deficiencies, the embodiments herein propose a new Information Element (IE), i.e., “retryAfter” (or retry-after), which may be defined in N1N2MsgTxfrFailureNotification, to inform the NF service consumer 302 to stop sending the new N1N2MessageTransfer request before the retry-after timer is timeout.

The NF service consumer 302 (e.g. the SMF 102) can suppress the subsequent procedures based on “retryAfter” IE. The NF service consumer 302 should not send the Namf_Communications_N1N2MessageTransfer before the retry-after timer is timeout. As a result, the unnecessary signal exchange between the NF service consumer 302 and the AMF 101 before the timeout of the retry-after timer may be reduced, and then the paging from the AMF 101 may be reduced and the RAN resources may be saved in an earlier phase.

In addition, an optional new cause value, “UE_NOT_REACHABLE”, may be defined in cause IE, to inform the NF service consumer 302 that the N1N2MessageTransfer was failed due to UE not reachable.

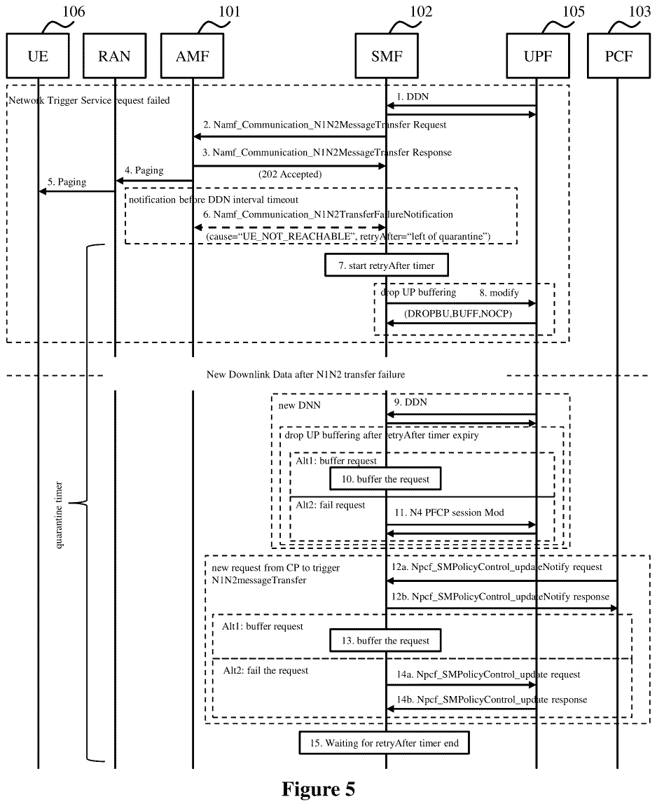

FIG. 5 is a schematic signaling chart showing the messages in an example procedure for suppressing N1N2 message transfer for failure notification, according to the embodiments herein. FIG. 5 describes the improved message suppressing sequence flow due to UE not reachable.

The N1N2 message may refer to the N1 signaling and/or the N2 signaling, which are sent over the N1 interface and N2 interface as shown in FIG. 1, respectively.

In an embodiment, the procedure for suppressing N1N2 message transfer for failure notification in FIG. 5 may include the following messages or steps:
Step 1. When a UPF 105 receives downlink data for a PDU session and there is no AN tunnel information stored in the UPF 105 for the PDU session, based on the instruction from the SMF 102, the UPF 105 may buffer the downlink data and send Downlink Data Notification (DDN) to the SMF 102.
Step 2. The SMF 102 may determine the AMF 101 and invoke the Namf_Communication_N1N2MessageTransfer to the AMF 101 including the PDU session ID of the PDU session.
Step 3. If the UE 106 is in CM-IDLE state at the AMF 101, and the AMF 101 is able to page the UE 106, the AMF 101 may send an Namf_Communication_N1N2MessageTransfer response to the SMF 102 immediately to indicate to the SMF 102 that the AMF 101 is attempting to reach the UE 106.
Step 4. The AMF 101 may send a paging message to NG-RAN node(s) via 3GPP access.
Step 5. The NG-RAN sends the paging message to the UE 106.
Step 6. The AMF 101 may notify the SMF 102 by sending an Namf_Communications_N1N2MessageTransfer failure notification to the notification target address provided by the SMF 102 in step 2, if the UE 106 does not respond to paging (i.e., there is a failure in paging the UE 106), the response body message may include “retryAfter” (i.e., retry-after) timer to request the NF service consumer 302 (such as the SMF 102) to stop sending the N1/N2 message before timeout of the timer. The response body message may include a failure cause, i.e., “the UE does not respond to paging”.

In an example, the “retryAfter” timer may be added in the Namf_Communications_N1N2MessageTransfer failure notification from the AMF 101 to make the NF consumer service 302 to throttle subsequent message for some period.

That is, the AMF 101 may provide a retry-after timer value to the NF service consumer 302 so that the NF service consumer 302 will retry the request after the expiry of the timer. When the retry-after timer is provided, the NF service consumer 302 shall not initiate the downlink messaging until the timer expires.

In an example, the N1N2MessageTransfer failure notification may include the data structure in the table 2.

TABLE 2
Data structures supported by the POST Request Body

| Data type | P | Cardinality | Description |
|---|---|---|---|
| N1N2MsgTxfrFail- | M | 1 | Representation of the N1/N2 message transfer failure notification. |
| ureNotification | | | The “cause” attribute shall be set to one of following cause value |
| | | | s (see clause 6.1.6.3.6): |
| | | | UE_NOT_RESPONDING |
| | | | UE_NOT_REACHABLE_FOR_SESSION |
| | | | TEMPORARY_REJECT_REGISTRATION_ONGOING |
| | | | TEMPORARY_REJECT_HANDOVER_ONGOING |
| | | | REJECTION_DUE_TO_PAGING_RESTRICTION |
| | | | AN_NOT_RESPONDING |
| | | | FAILURE_CAUSE_UNSPECIFIED |
| | | | The AMF may additionally provide the “retryAfter” IE depicting the time on |
| | | | how long the NF consumer should throttle sending further N1/N2 message |
| | | | to the UE, e.g., when the UE is not responding to paging. |

In an example, the N1N2MessageTransfer failure notification may be configured as in the table 3.

TABLE 3
Definition of type NIN2MsgTxfrFailureNotification

| Attribute name | Data type | P | Cardinality | Description |
|---|---|---|---|---|
| Cause | N1N2MessageTrans- | M | 1 | This IE shall provide the result of the N1/N2 |
| | ferCause | | | message transfer at the AMF. |
| n1n2MsgDataUri | Uri | M | 1 | This IE shall contain the N1N2Message Transfer |
| | | | | request resource URI returned in the Location |
| | | | | header when the N1/N2 message transfer was |
| | | | | initiated (see clause 6.1.3.5.3.1). |
| | | | | This IE shall be used by the NF Service Consumer |
| | | | | to correlate the notification with the UE or session for |
| | | | | which the earlier N1/N2 message transfer was |
| | | | | initiated. |
| | | | | If no Location header was returned when the N1/N2 |
| | | | | message transfer was initiated, e.g. when a 200 OK |
| | | | | response was sent for a UE in RRC inactive state, |
| | | | | this IE shall be set to a dummy URI, i.e. an URI with |
| | | | | no authority and an empty path (e.g. “http:”). |
| retryAfter | Uinteger | O | 0 . . . 1 | This IE may be included if the AMF requests the NF |
| | | | | Service Consumer to throttle sending further N1/N2 |
| | | | | messages for a short period, e.g. when UE is not |
| | | | | responding to paging. |
| | | | | When present, this IE indicates the throttle period in |
| | | | | seconds. The NF consumer should throttle sending |
| | | | | subsequent N1/N2 messages during the period. |

In addition, the failure cause may be enhanced. In an example, the common application errors defined in 3GPP TS 29.500, which may also be used for the Namf_Communication service, may be enhanced. Table 4 shows the enhanced application errors.

TABLE 4
application errors

| | HTTP status | |
|---|---|---|
| Application Error | code | Description |
| NF_CONSUMER_REDIRECT_ONE_TXN | 307 | The request has been asked to be redirected |
| | Temporary | to a specified target. |
| | Redirect | |
| HANDOVER_FAILURE | 403 | Creation of UE context or relocation in the |
| | Forbidden | target AMF failed during Handover procedure |
| | | causing a failure of handover. |
| INTEGRITY_CHECK_FAIL | 403 | Integrity check of the complete registration |
| | Forbidden | message included in the UE context transfer |
| | | request failed. |
| EBI_EXHAUSTED | 403 | Allocation of EPS Bearer ID failed due to |
| | Forbidden | exhaustion of EBI as the maximum number |
| | | of EBIs has already been allocated to the UE. |
| EBI_REJECTED_LOCAL_POLICY | 403 | Allocation of EPS Bearer ID failed due to |
| | Forbidden | local policy at the AMF as specified in clause |
| | | 4.11.1.4.1 of 3GPP TS 23.502 [3]. |
| EBI_REJECTED_NO_N26 | 403 | The allocation of EPS Bearer ID was rejected |
| | Forbidden | when the AMF is in a serving PLMN that |
| | | does not support 5GS-EPS interworking |
| | | procedures with N26 interface. |
| SUPI_OR_PEI_UNKNOWN | 403 | The SUPI or PEI included in the message is |
| | Forbidden | unknown. |
| UE_IN_NON_ALLOWED_AREA | 403 | UE is currently in a non-allowed area hence |
| | Forbidden | the N1/N2 message transfer cannot be |
| | | completed because the request is not |
| | | associated with a regulatory prioritized |
| | | service. |
| UNSPECIFIED | 403 | The request is rejected due to unspecified |
| | Forbidden | reasons. |
| SM_CONTEXT_RELOCATION_REQUIRED | 403 | The request is rejected because the SM |
| | Forbidden | Context should be relocated to another SMF, |
| | | e.g. when AMF detects that an I-SMF or |
| | | V-SMF insertion, change or removal is |
| | | needed, as specified in clause 4.23 of |
| | | 3GPP TS 23.502 [3]. |
| UE_WITHOUT_N1_LPP_SUPPORT | 403 | UE does not support LPP in N1 mode hence |
| | Forbidden | the N1 LPP message cannot be sent to the |
| | | UE. |
| INVALID_SM_CONTEXT | 403 | The request is rejected because the SM |
| | Forbidden | Context is invalid for the PDU session, i.e. |
| | | active SM Context for the PDU session (with |
| | | same PDU Session ID) has been created on |
| | | another SMF. |
| | | (NOTE) |
| CONTEXT_NOT_FOUND | 404 Not | The requested UE Context does not exist on |
| | Found | the AMF |
| HIGHER_PRIORITY_REQUEST_ONGOING | 409 | Paging triggered N1/N2 transfer cannot be |
| | Conflict | initiated since already there is a paging due |
| | | to a higher priority session ongoing. |
| TEMPORARY_REJECT_REGISTRATION_ONGOING | 409 | N1/N2 message transfer towards UE/AN |
| | Conflict | cannot be initiated or the EBI assignment |
| | | fails due to an ongoing registration |
| | | procedure. |
| TEMPORARY_REJECT_HANDOVER_ONGOING | 409 | N1/N2 message transfer towards UE/AN |
| | Conflict | cannot be initiated due to an ongoing Xn or |
| | | N2 handover procedure, or the EBI |
| | | assignment fails due to an ongoing N2 |
| | | handover procedure or an ongoing Xn |
| | | handover procedure. |
| UE_IN_CM_IDLE_STATE | 409 | N2 message transfer towards 5G-AN cannot |
| | Conflict | be initiated due to the UE being in CM-IDLE |
| | | state for the Access Network Type |
| | | associated to the PDU session. |
| MAX_ACTIVE_SESSIONS_EXCEEDED | 409 | If the RAT type is NB-IoT, and the UE |
| | Conflict | already has 2 PDU Sessions with active user |
| | | plane resources. |
| REJECTION_DUE_TO_PAGING_RESTRICTION | 409 | If Paging Restrictions information restricts the |
| | Conflict | N1N2Message Transfer request from causing |
| | | paging as defined in 3GPP TS 23.501 [2] |
| | | clause 5.38.5. |
| UE_NOT_REACHABLE | 504 | The UE is not reachable for paging. |
| | Gateway | |
| | Timeout | |
| UE_NOT_RESPONDING | 504 | The UE is not responding for paging. |
| | Gateway | |
| | Timeout | |

(NOTE):
More than one SM Contexts may be present in the network for the same PDU Session ID, e.g. when the UE established a new PDU session with the same PDU Session ID and the AMF failed to release the old SM Context in the old SMF. In such a scenario, if the old SMF tries to send N1 and/or N2 Message to the RAN/UE, the AMF shall respond with this application error if the AMF identified that service operation is invoked by the SMF holding the old SM Context.

Step 7. The SMF 102 may start the retry-after timer as received in the step 6.
Step 8. The SMF 102 may inform the UPF 105 to drop the buffer.

During the retry-after timer is running, the SMF 102 may further receive a new downlink data notification.
Step 9. The UPF 105 may send Downlink Data Notification (DDN) to the SMF 102.
Step 10. As an alternative, the SMF 102 may buffer the request and handle it after the retry-after timer is expired.
Step 11. As an alternative, the SMF 102 may detect the retry-after timer is running, and the SMF 102 may stop (i.e., suppress) sending the Namf_Communication_N1N2MessageTransfer to the AMF 101 and inform the UPF 105 to drop the buffer.

The SMF 102 may receive the Control Plane (CP) request during the retry-after timer is running.
Step 12. During the retry-after timer is running, the SMF 102 may receive the SM policy control update notification request from the PCF 103. The SMF 102 may acknowledge the notification.

There are two alternatives for the new NF request which is related to N1N2MessageTransfer.
Step 13. As an alternative, the SMF 102 may buffer the request and handle the request after the retry-after timer expires.
Step 14. As another alternative, the SMF 102 may stop (i.e., suppress) handling the SM policy control update request and send the enforcement failure request to the PCF 103.
Step 15. The SMF 102 may wait for the retry-after timer's expiry.

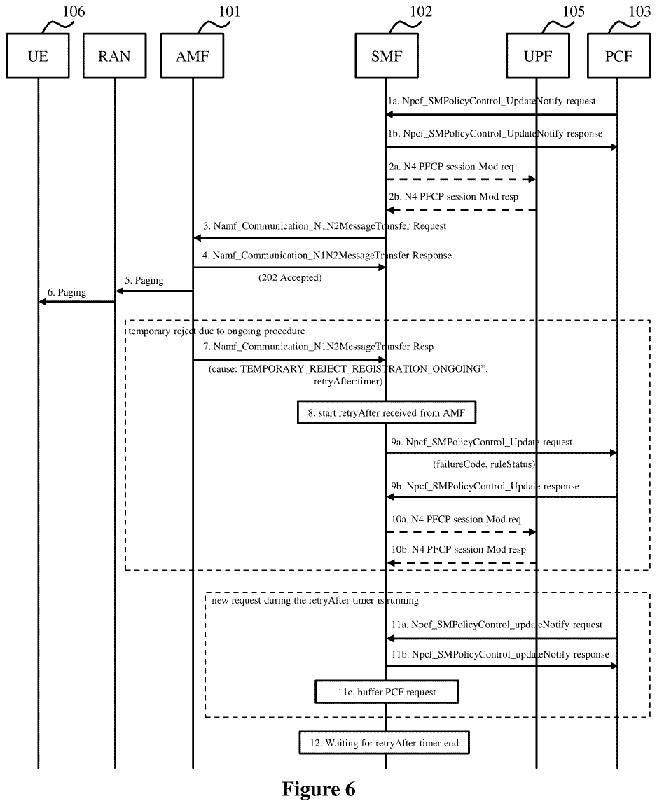

FIG. 6 is a schematic signaling chart showing the messages in another example procedure for suppressing N1N2 message transfer for failure notification, according to the embodiments herein. FIG. 6 describes the improved message suppressing sequence flow due to temporary rejection for ongoing procedure.

In an embodiment, the procedure for suppressing N1N2 message transfer for failure notification in FIG. 6 may include the following messages or steps:
Step 1. The procedure may be triggered by the PCF 103.
   Step 1a. (PCF initiated SM policy association modification) The PCF 103 may perform a PCF initiated SM policy association modification procedure to notify the SMF 102 about the modification of policies. This may e.g. have been triggered by a policy decision or upon the request of the AF 104.
   Step 1b. The SMF 102 may acknowledge the SM policy association modification request.
Step 2. The SMF 102 may initiate the UPF session setup or modification procedure for new or modified Quality of Service (QoS) flow(s).
   Step 2a. The SMF 102 may update the UPF 105 with N4 Rule(s) related to the new or modified QoS flow(s).
   Step 2b. The UPF(s) 105 may respond to the SMF 102.
Step 3. If the UE 106 is in a CM-IDLE state at the AMF 101, and the AMF 101 is able to page the UE 106, the AMF may send an Namf_Communication_N1N2MessageTransfer response to the SMF 102 immediately to indicate to the SMF 102 that the AMF 101 is attempting to reach the UE 106.
Step 4. For SMF requested modification, the SMF 102 may invoke an Namf_Communication_N1N2MessageTransfer ([N2 SM information](PDU session ID, QFI(s), QoS profile(s), [alternative QoS profile(s)], session-AMBR, [CN tunnel information], QoS monitoring indication, QoS monitoring reporting frequency, [TSCAI(s)]), N1 SM container (PDU session modification command (PDU session ID, QoS rule(s), QoS flow level QoS parameters if needed for the QoS flow(s) associated with the QoS rule(s), QoS rule operation and QoS flow level QoS parameters operation, Session-AMBR))).
Step 5. The AMF 101 may send a paging message to NG-RAN node(s) via 3GPP access.
Step 6. The NG-RAN may send the paging message to the UE 106.
Step 7. The AMF 101 may notify the SMF 102 by sending an Namf_Communications_N1N2MessageTransfer failure notification to the notification target address provided by the SMF in step 2 if the AMF 101 has initiated paging to reach the UE 106 but there is an ongoing registration procedure (i.e., there is a failure in paging to the UE 106), the response body message may include the retry-after timer to request the NF service consumer 302 to stop sending the N1/N2 message before timeout of the timer. In addition, the response body message may include the failure cause, i.e., there is an ongoing registration procedure. The tables 2-4 may be applicable for this message.
Step 8. The SMF 102 may start the retry-after timer.
Step 9. The SMF 102 may send Npcf_SMPolicyControl_Update request (step 9a) to report the failure of the enforcement of the PCC rule(s). The PCF 103 may respond with Npcf_SMPolicyControl_Update (step 9b) with 200 OK status code.
Step 10. The SMF 102 may send the UPF session release or modification procedure to roll back the new or modified QoS flow(s) if the N4 rule(s) were setup or modified in step 2.

The SMF 102 may receive new request when the retry-after timer is running.
Step 11. When the retry-after timer is running, the SMF 102 may receive the SM policy control update notification request from the PCF 103. The SMF 102 may acknowledge the notification.

There are two alternatives for the new NF request which is related to N1N2MessageTransfer.
Step 12. As an alternative, the SMF 102 may buffer the request and handle the request after the retry-after timer expires.

As another alternative, the SMF 102 may stop (i.e., suppress) handling the SM policy control update request and send the enforcement failure request to the PCF 103.
Step 13. The SMF 102 may wait for the retry-after timer's expiry.

With the embodiments, the NF service consumer 302 may be aware of what the problem is and when it can reattempt or send the N1N2MessageTransfer requests to the AMF 101 in N1N2Transfer failure notification.

With the embodiments, by defining a retry-after timer in N1N2Transfer failure notification, the unnecessary signal exchange between the NF service consumer 302 and the AMF 101 before the timeout of the retry-after timer may be reduced.

In addition, with the embodiments, the signaling may be simplified and the same error situation may be avoided.

In addition, with the embodiments, the paging from the AMF 101 may be reduced and the RAN resources may be saved in an earlier phase.

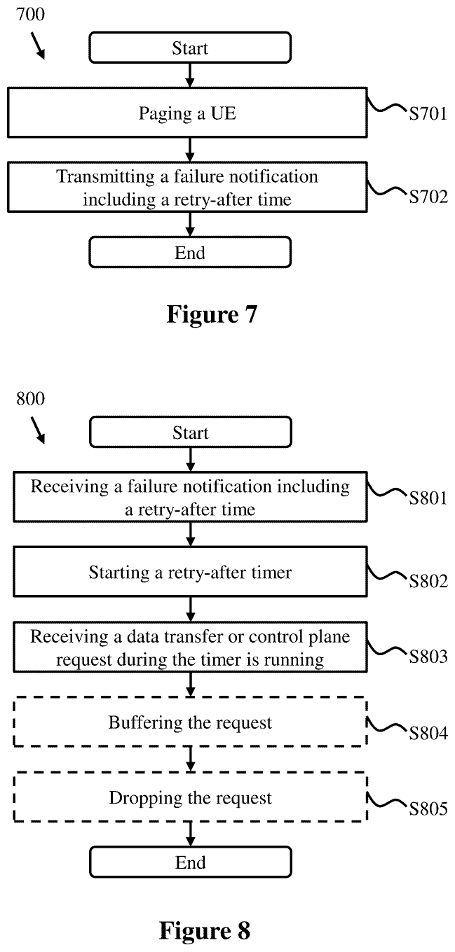

FIG. 7 is a schematic flow chart showing an example method 700 in the first network function (such as the AMF 101), according to the embodiments herein.

The method 700 may begin with step S701, in which the first network function (such as the AMF 101) may page a UE.

Then, the method 700 may proceed to step S702, in which the first network function (such as the AMF 101) may transmit, to a second network function implementing a network function consumer (such as the SMF 102), a failure notification message, in response to a failure in the paging. The failure notification message may include a first parameter indicating a retry-after time. A transfer of message from the second network function to the first network function may be suppressed during the retry-after time.

In an embodiment, the failure notification message may be N1N2 message transfer failure notification message.

In an embodiment, the second network function may implement a SMF, SMSF, LMF, PCF, GMLC, NEF or UDM.

In an embodiment, the failure notification message may further include a second parameter indicating a failure cause.

In an embodiment, the failure cause may be that the UE is not reachable or there is an ongoing procedure.

In an embodiment, the ongoing procedure may be an ongoing registration procedure or an ongoing handover procedure.

In an embodiment, N1N2 message transfer request message may be suppressed during the retry-after time.

In an embodiment, the second network function may suppress or not suppress the new N1N2 message transfer request message, according to the priority of the new N1N2 message transfer request message. For example, if the new N1N2 message transfer request message has a priority higher than the priority of the N1N2 message transfer request message which triggers the retry-after time, the second network function may transfer the N1 and/or N2 messages.

The above steps are only examples, and the first network function (such as the AMF 101) may perform any actions described with respect to FIGS. 2-6, to suppress N1N2 message transfer for failure notification.

FIG. 8 is a schematic flow chart showing an example method 800 in the second network function (such as the SMF 102), according to the embodiments herein.

The method 800 may begin with step S801, in which the second network function (such as the SMF 102) may receive, from a first network function (such as the AMF 101), a failure notification message including a first parameter indicating a retry-after time. The failure notification message may be transmitted in response to a failure in a paging from the first network function to a UE (such as the UE 106).

In an embodiment, the failure notification message may be N1N2 message transfer failure notification message.

In an embodiment, the second network function may implements a SMF, SMSF, LMF, PCF, GMLC, NEF or UDM.

In an embodiment, the failure notification message may further include a second parameter indicating a failure cause.

In an embodiment, the failure cause may be that the UE is not reachable or there is an ongoing procedure.

In an embodiment, the ongoing procedure may be an ongoing registration procedure or an ongoing handover procedure.

Then, the method 800 may proceed to step S802, in which the second network function (such as the SMF 102) may start a retry-after timer, to suppress a transfer of message from the second network function to the first network function during the retry-after time.

In an embodiment, N1N2 message transfer request message may be suppressed during the retry-after time.

In an embodiment, the second network function may suppress or not suppress the new N1N2 message transfer request message, according to the priority of the new N1N2 message transfer request message. For example, if the new N1N2 message transfer request message has a priority higher than the priority of the N1N2 message transfer request message which triggers the retry-after time, the second network function may transfer the N1 and/or N2 messages.

Then, the method 800 may proceed to step S803, in which the second network function (such as the SMF 102) may receive a data transfer request from a third network function (such as the UPF 105). In an embodiment, the data transfer request may be a Downlink Data Notification (DDN) request.

Alternatively, in the step S803, the second network function (such as the SMF 102) may receive a control plane request from a fourth network function (such as the PCF 103).

In an embodiment, the control plane request may be a session management policy control update notify request or session management policy control update response. In an embodiment, the session management policy may be a PCC rule.

Then, the method 800 may proceed to step S804, in which the second network function (such as the SMF 102) may buffer the data transfer request during the retry-after time; and handle the data transfer request after the retry-after time.

Alternatively, in the step S804, the second network function (such as the SMF 102) may buffer the control plane request during the retry-after time; and handle the control plane request after the retry-after time.

Then, the method 800 may proceed to step S805, in which the second network function (such as the SMF 102) may stopping a transfer of message to the first network function; and informing the third network function to drop a buffer.

Alternatively, in the step S805, the second network function (such as the SMF 102) may stop handling the control plane request; and transmit, to the fourth network function, an enforcement failure message.

In an embodiment, the enforcement failure message may further include at least one of a third parameter indicating a failure code and a fourth parameter indicating rule status.

The above steps are only examples, and the second network function (such as the SMF 102) may perform any actions described with respect to FIGS. 2-6, to suppress N1N2 message transfer for failure notification.

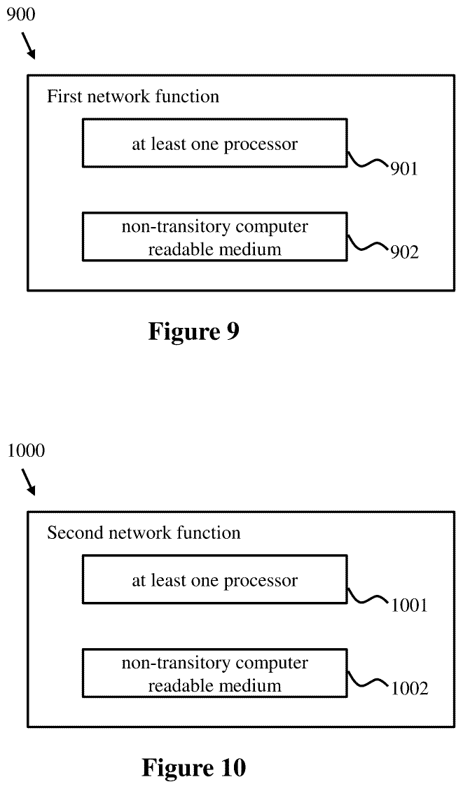

FIG. 9 is a schematic block diagram showing an example first network function 900 (such as the AMF 101), according to the embodiments herein.

In an embodiment, the first network function 900 may include at least one processor 901; and a non-transitory computer readable medium 902 coupled to the at least one processor 901. The non-transitory computer readable medium 902 may store instructions executable by the at least one processor 901, whereby the at least one processor 901 may be configured to perform the steps in the example method 700 as shown in the schematic flow chart of FIG. 7; the details thereof are omitted here.

Note that, the first network function 900 may be implemented as hardware, software, firmware and any combination thereof. For example, the first network function 900 may include a plurality of units, circuitries, modules or the like, each of which may be used to perform one or more steps of the example method 700 or one or more steps related to the AMF 101.

It should be understood that, the first network function 900 may be implemented either as a network element on a dedicated hardware, as a software instance running on a dedicated hardware, or as a virtualized function instantiated on an appropriate platform, e.g. on a cloud infrastructure.

FIG. 10 is a schematic block diagram showing an example second network function 1000 (such as the SMF 102 or the NF consumer 302), according to the embodiments herein.

In an embodiment, the second network function 1000 may include at least one processor 1001; and a non-transitory computer readable medium 1002 coupled to the at least one processor 1001. The non-transitory computer readable medium 1002 may store instructions executable by the at least one processor 1001, whereby the at least one processor 1001 may be configured to perform the steps in the example method 800 as shown in the schematic flow chart of FIG. 8; the details thereof are omitted here.

Note that, the second network function 1000 may be implemented as hardware, software, firmware and any combination thereof. For example, the second network function 1000 may include a plurality of units, circuitries, modules or the like, each of which may be used to perform one or more steps of the example method 800 or one or more steps related to the SMF 102 or the NF consumer 302.

It should be understood that, the second network function 1000 may be implemented either as a network element on a dedicated hardware, as a software instance running on a dedicated hardware, or as a virtualized function instantiated on an appropriate platform, e.g. on a cloud infrastructure.

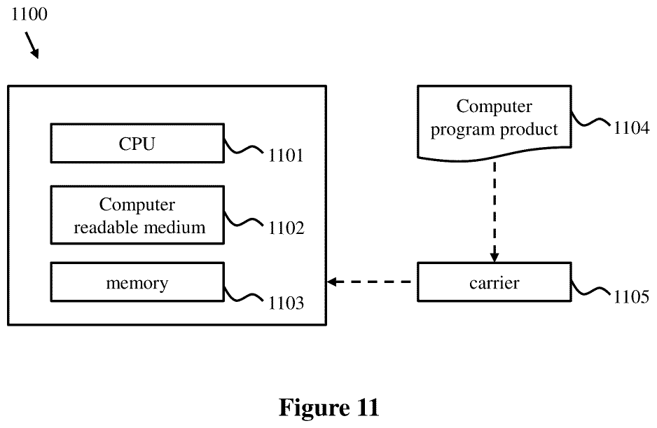

FIG. 11 is a schematic block diagram showing an example computer-implemented apparatus 1100, according to the embodiments herein. In an embodiment, the apparatus 1100 may be configured as any of the above mentioned apparatuses, such as the AMF 101, the SMF 102, the NF consumer 302, the first network function 900, or the second network function 1000.

In an embodiment, the apparatus 1100 may include but not limited to at least one processor such as Central Processing Unit (CPU) 1101, a computer-readable medium 1102, and a memory 1103. The memory 1103 may comprise a volatile (e.g., Random Access Memory, RAM) and/or non-volatile memory (e.g., a hard disk or flash memory). In an embodiment, the computer-readable medium 1102 may be configured to store a computer program and/or instructions, which, when executed by the processor 1101, causes the processor 1101 to carry out any of the above mentioned methods.

In an embodiment, the computer-readable medium 1102 (such as non-transitory computer readable medium) may be stored in the memory 1103. In another embodiment, the computer program may be stored in a remote location for example computer program product 1104 (also may be embodied as computer-readable medium), and accessible by the processor 1101 via for example carrier 1105.

The computer-readable medium 1102 and/or the computer program product 1104 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP Technical Specification 3GPP TS 29.518 V17.7.0.

### Title: Retry-After for N1N2 Message Transfer Failure

### Reason for Change:

As specified in TS 29.518, when an NF service consumer initiates the N1/N2 Message Transfer service operation, AMF may respond with an error status code and at the same time provide a retry timer to avoid the NF consumer frequently retry N1/N2 messages and cause unnecessary load on AMF and negative KPI with failure responses. E.g., if the UE is in 3GPP access and there is already an ongoing paging procedure with higher or same priority as specified in the TS.

Practically, the AMF may provide a retry timer in other scenarios, e.g., if there is an ongoing registration procedure, or when the AMF had just paged the UE but UE is not responding, the AMF may ask the NF consumer to postpone sending subsequent N1/N2 message towards the UE for a certain period.

Additionally, if paging is issued when the UE is in CM-IDLE and reachable for 3GPP access, AMF responds with a response code 202 with cause “ATTEMPTING_TO_REACH_UE”. If the UE is not responding, the AMF sends N1N2Transfer Failure Notification to NF service consumer. In such a notification, the AMF may ask the NF consumer to postpone sending subsequent N1/N2 message towards the UE for a certain period.

### Summary of Change:

1/Define new IE retryAfter in N1N2MsgTxfrFailureNotification, to allow AMF to inform the NF service consumer to throttle sending N1/N2 for certain period.

2/Update service operation and resource definition to indicate that the AMF may provide a timer in order for the NF consumer to throttle sending further N1/N2 messages to the UE.

3/Define new application for UE not responding.

4/Update OpenAPI accordingly.

### Consequences if not Approved:

The NF Service Consumer will still send the N1N2MessageTransfer request to AMF when the AMF has identified N1/N2 messages cannot be transferred at the moment, which leads to unnecessary network traffic and waste of RAN resources.

### Proposed Changes:

***1st Change***(the Underline Indicates the Content to be Added to the 3GPP Technical Specification)

### 5.2.2.3.1.2 Detailed Behavior of the AMF

When an NF service consumer is requesting to send N1 and/or N2 information and the UE is in CM-IDLE state for the access type for which the N1 and/or N2 information is related (called “associated access type” hereafter in this clause), the requirements specified in clause 5.2.2.3.1.1 shall apply with the following modifications:

NOTE: N1 and/or N2 Session Management information is related to the access type of the targeted PDU session for a single access PDU session, or to the Target Access received in the request for a MA PDU session; LCS related N2 (NRPPa) information is related to 3GPP access in this release of specification.

4xx and 5xx response cases shall also apply to UEs in CM-CONNECTED state, when applicable.

### 2xx Response Cases:

Case A: When UE is CM-IDLE in 3GPP access and the associated access type is 3GPP access:

a) Same as step 2a of FIG. 5.2.2.3.1.1-1, the AMF should respond with the status code “200 OK”, if “skipInd” attribute is set to “true” in the request body, with a response body that carries the cause “N1_MSG_NOT_TRANSFERRED”.

b) Same as step 2a of FIG. 5.2.2.3.1.1-1, the AMF shall respond with the status code “202 Accepted”, if the asynchronous type communication is invoked and hence the UE is not paged, update the UE context and store N1 and/or N2 information and initiate communication with the UE and/or 5G-AN when the UE becomes reachable. In this case the AMF shall provide the URI of the resource in the AMF in the “Location” header of the response, which contains information regarding the stored N1/N2 message. The AMF shall also provide a response body containing the cause, “WAITING_FOR_ASYNCHRONOUS_TRANSFER” that represents the current status of the N1/N2 message transfer;

c) Same as step 2a of FIG. 5.2.2.3.1.1-1, the AMF shall respond with the status code “202 Accepted”, if paging is issued when the UE is in CM-IDLE and reachable for 3GPP access, with a response body that carries a cause “ATTEMPTING_TO_REACH_UE” as specified in clause 4.2.3.3 and 5.2.2.2.7 of 3GPP TS 23.502 [3].

Case B: When UE is CM-IDLE in Non-3GPP access but CM-CONNECTED in 3GPP access and the associated access type is Non-3GPP access:

a) Same as step 2a of FIG. 5.2.2.3.1.1-1, the AMF shall respond with the status code “200 OK” with cause “N1_N2_TRANSFER_INITIATED” and initiate N1 NAS SM message transfer via 3GPP access, if the NF service consumer (i.e. SMF) requests to send only N1 NAS SM message without any associated N2 SM information, and the current access type related to the PDU session is Non-3GPP access and the UE is CM-CONNECTED in 3GPP access.

b) Same as step 2a of FIG. 5.2.2.3.1.1-1, the AMF shall respond with the status code “202 Accepted”, if NAS Notification procedure is issued when the UE is in CM-CONNECTED in 3GPP access, with a response body that carries a cause “ATTEMPTING_TO_REACH_UE” as specified in step 4c of clause 4.2.3.3 and 5.2.2.2.7 of 3GPP TS 23.502 [3].

Case C: When UE is CM-IDLE in both Non-3GPP access and 3GPP access and the associated access type is Non-3GPP access:

All the bullets specified in Case A are applicable.

The NF Service Consumer shall not send any further signalling for the UE if it receives a POST response body with a cause “ATTEMPTING_TO_REACH_UE” unless it has higher priority signalling. In such a case the response shall include the “Location” header containing the URI of the resource created in the AMF, which holds the status of the N1/N2 message transfer, e.g. “ . . . /n1-n2-messages/{n1N2MessageId}”. The AMF shall:
store the N1 and/or N2 information related to 3GPP access and, when the UE responds with a Service Request, shall initiate communication with the UE and/or 5G-AN using the stored N1 and/or N2 information;
store the N1 NAS SM information related to Non-3GPP access if no N2 information was received and the AMF initiated paging towards the UE. Later when the UE responds with a Service Request, the AMF shall initiate communication with the UE using the stored N1 information via 3GPP access;
inform the SMF which invoked the service operation, that the access type of the PDU Session can be changed from Non-3GPP access to 3GPP access as specified in clause 5.2.2.3.2.1 of 3GPP TS 29.502 [16], when the UE responds with a “List Of Allowed PDU Sessions” and the indicated non-3GPP PDU session of the N2 (and N1 if received) information is included in the list; or
notify the NF which invoked the service operation, as specified in clause 5.2.2.3.2, if the Notification URI is provided, when the AMF determines that the paging or NAS Notification has failed or when the UE responds with a “List Of Allowed PDU Sessions” and the indicated Non-3GPP PDU session of the N2 (and N1 if received) information is not included in the list.

### 4xx Response Cases:

Same as step 2b of FIG. 5.2.2.3.1.1-1, the AMF shall respond with status code “409 Conflict” in the following cases:
if the UE is in 3GPP access and there is already an ongoing paging procedure with higher or same priority, the AMF shall set the application error as “HIGHER_PRIORITY_REQUEST_ONGOING” in the “cause” attribute of the ProblemDetails structure of the POST response body. The AMF may provide a retry timer value to the NF Service Consumer in order for the NF Service Consumer to retry the request after the expiry of the timer. When the retry timer is provided, the NF Service Consumer shall not initiate the downlink messaging until the timer expires. The AMF may also provide the ARP value of the QoS flow that has triggered the currently ongoing highest priority paging, so that the NF Service Consumer (e.g. SMF) knows that if any subsequent trigger initiating downlink messaging for a QoS flow with the same or lower priority happens.
if there is an ongoing registration procedure (see clause 4.2.3.3 of 3GPP TS 23.502 [3]) the AMF shall set the application error as “TEMPORARY_REJECT_REGISTRATION_ONGOING” in the “cause” attribute of the ProblemDetails structure in the POST response body; The AMF may provide a retry timer value to the NF Service Consumer in order for the NF Service Consumer to retry the request after the expiry of the timer. When the retry timer is provided, the NF Service Consumer shall not initiate the downlink messaging until the timer expires.
if this is a request to transfer a N2 PDU Session Resource Modify Request or a N2 PDU Session Resource Release Command to a 5G-AN and if the UE is in CM-IDLE state at the AMF for the Access Network Type associated to the PDU session (see clauses 4.3.3 and 4.3.4 of 3GPP TS 23.502 [3] and clause 5.3.2.1 of 3GPP TS 23.527 [33]), the AMF shall set the application error “UE_IN_CM_IDLE_STATE” in the “cause” attribute of the ProblemDetails structure in the POST response body.
if there is an ongoing Xn or N2 handover procedure (see clause 4.9.1.2.1 and 4.9.1.3.1 of 3GPP TS 23.502 [3]) the AMF shall set the application error as “TEMPORARY_REJECT_HANDOVER_ONGOING” in the “cause” attribute of the ProblemDetails structure in the POST response body, if the AMF rejects the request due to the on-going handover.
if the RAT Type is NB-IoT, and the UE already has 2 PDU Sessions with active user plane resources, the AMF shall set the application error as “MAX_ACTIVE_SESSIONS_EXCEEDED” in POST response body.
if Paging Restrictions information restricts the N1N2MessageTransfer request from causing paging (see clause 4.2.3.3 of 3GPP TS 23.502 [3]) the AMF shall set the application error as “REJECTION_DUE_TO_PAGING_RESTRICTION” in the “cause” attribute of the ProblemDetails structure in the POST response body.
Same as step 2b of FIG. 5.2.2.3.1.1-1, the AMF shall respond with the status code “403 Forbidden”, if the UE is in a Non-Allowed Area and the service request is not for regulatory prioritized service. The AMF shall set the application error as “UE_IN_NON_ALLOWED_AREA” in POST response body.
The NF service consumer (i.e. the SMF) that receives this application error may suppress subsequent message (e.g. N1N2MessageTransfer) to the AMF for non regulatory prioritized service. In this case, the NF service consumer (i.e. the SMF) should subscribe the Reachability-Report event for “UE Reachability Status Change” from the AMF, so as to get notified by the AMF when the UE becomes reachable again.
Same as step 2b of FIG. 5.2.2.3.1.1-1, the AMF shall respond with the status code “403 Forbidden”, if the NF service consumer (e.g. an LMF) is requesting to send N1 LPP message to the UE and the UE has indicated that it does not support LPP in N1 mode during registration procedure (see clause 5.5.1.2.2 and 5.5.1.3.2 of 3GPP TS 24.501 [11]). The AMF shall set the application error to “UE_WITHOUT_N1_LPP_SUPPORT” in POST response body.
Same as step 2b of FIG. 5.2.2.3.1.1-1, the AMF shall respond with the status code “403 Forbidden”, if the request body includes an nfId IE indicating an SMF instance which is different from the stored SMF instance hosting the SM Context of the PDU session. The AMF shall set the application error to “INVALID_SM_CONTEXT” in POST response body. During procedures with SM Context relocation, e.g. UE mobility procedures with I-SMF insertion/change/removal, the AMF shall allow N1N2MessageTransfer from both SMF instances holding the old and new SM Contexts.

The NF service consumer (i.e. the SMF) that receives this application error shall remove the SM Context for the PDU session and release the PDU session resource in (H-)SMF if available. The SMF shall not send a SMContextStatusNotification to the AMF for the PDU session release.

### 5xx Response Cases:

Same as step 2b of FIG. 5.2.2.3.1.1-1, the AMF shall respond with the status code “504 Gateway Timeout”, if the UE is currently unreachable (e.g., due to the UE in MICO mode, the UE using extended idle mode DRX or the UE is only registered over Non-3GPP access and its state is CM-IDLE). The AMF shall set the application error as “UE_NOT_REACHABLE” in POST response body. If Extended Buffering Support Indication is received in the request, the AMF shall include the Estimated Maximum Waiting time in the response body when the message is rejected due to the UE in MICO mode or the UE using extended idle mode DRX.
step 2b of FIG. 5.2.2.3.1.1-1, the AMF may respond with the status code “504 Gateway Timeout”, if the UE is temporarily not responding (e.g., not responding to the paging). The AMF shall set the application error as “UE_NOT RESPONDING” in POST response body. The AMF may provide a retryAfter timer value to the NF Service Consumer in order for the NF Service Consumer to throttle sending further downlink request before the expiry of the timer. When the retry timer is provided, the NF Service Consumer should not initiate the downlink messaging until the timer expires
   ***2nd Change***(the Underline Indicates the Content to be Added to the 3GPP Technical Specification)

### 5.2.2.3.2 N1N2Transfer Failure Notification

The AMF Uses this Notification to Inform the NF Service Consumer that Initiated an wearlier

Namf_Communication_N1N2MessageTransfer, that the AMF failed to deliver the N1 and/or N2 message. The HTTP POST method shall be used on the notification callback URI provided by the NF service consumer as specified in clause 5.2.2.3.1.2.

FIG. 5.2.2.3.2-1 N1N2Transfer Failure Notification for UE related signaling

1. If the NF service consumer had provided a notification URI (see clause 5.2.2.3.1.2), the AMF shall send a POST request to the NF Service Consumer on that Notification URI when the AMF determines that:
the paging or NAS Notification has failed;
the indicated non-3GPP PDU session is not allowed to move to 3GPP access;
the UE has rejected the page as defined in 3GPP TS 23.501 [2] clause 5.38.4;
the delivery of the N1 message fails, e.g. in case the UE is in RRC Inactive and NG-RAN paging was not successful or in case an Xn or N2 handover is being triggered at the NG-RAN

The AMF shall include the N1N2MessageTransfer request resource URI returned earlier in the N1N2MessageTransfer response if any (see clause 5.2.2.3.1.2), otherwise a dummy URI (see clause 6.1.6.2.30), in the POST request body. The AMF shall also include a N1/N2 message transfer cause information in the POST request body and set the value as specified in clause 6.1.5.6.3.1.

The NF Service Consumer shall delete any stored representation of the N1N2MessageTransfer request resource URI upon receiving this notification.

The AMF may also include a “retryAfter” IE in the POST request body in order for the NF consumer to throttle sending downlink throttle further downlink request before the expiry of the timer, e.g. to reduce unnecessary paging to an unresponding UE for a period of time to save the RAN resources.

2. The NF Service Consumer shall send a response with “204 No Content” status code.

On failure or redirection, one of the HTTP status codes together with the response body listed Table 6.1.5.6.3.1-2 shall be returned.

***3rd Change***(the Underline Indicates the Content to be Added to the 3GPP Technical Specification)

### 6.1.5.6.3.1POSt

This method sends an N1/N2 message transfer failure notification to the NF Service Consumer (e.g. SMF).

This method shall support the request data structures specified in table 6.1.5.6.3.1-1 and the response data structures and response codes specified in table 6.1.5.6.3.1-3.

TABLE 6.1.5.6.3.1-1
Data structures supported by the POST Request Body

| Data type | P | Cardinality | Description |
|---|---|---|---|
| N1N2MsgTxfrFail- | M | 1 | Representation of the N1/N2 message transfer failure notification. |
| ureNotification | | | The “cause” attribute shall be set to one of following cause value s (see |
| | | | clause 6.1.6.3.6): |
| | | | UE_NOT_RESPONDING |
| | | | UE_NOT_REACHABLE_FOR_SESSION |
| | | | TEMPORARY_REJECT_REGISTRATION_ONGOING |
| | | | TEMPORARY_REJECT_HANDOVER_ONGOING |
| | | | REJECTION_DUE_TO_PAGING_RESTRICTION |
| | | | AN_NOT_RESPONDING |
| | | | FAILURE_CAUSE_UNSPECIFIED |
| | | | The AMF may additionally provide the “retryAfter” IE depicting |
| | | | the time on how long the NF consumer should throttle sending |
| | | | further N1/N2 message to the UE, e.g., when the UE is not |
| | | | responding to paging. |

TABLE 6.1.5.6.3.1-2
Data structures supported by the POST Response Body

| | | | Response | |
|---|---|---|---|---|
| Data type | P | Cardinality | codes | Description |
| n/a | | | 204 No | This case represents a successful notification of |
| | | | Content | the N1/N2 message transfer to the NF service |
| | | | | consumer. |
| RedirectResponse | O | 0 . . . 1 | 307 | Temporary redirection. The NF service consumer |
| | | | Temporary | shall generate a Location header field containing a |
| | | | Redirect | URI pointing to the endpoint of another NF service |
| | | | | consumer to which the notification should be sent. |
| | | | | If an SCP redirects the message to another SCP |
| | | | | then the location header field shall contain the |
| | | | | same URI or a different URI pointing to the |
| | | | | endpoint of the NF service consumer to which the |
| | | | | notification should be sent. |
| RedirectResponse | O | 0 . . . 1 | 308 | Permanent redirection. The NF service consumer |
| | | | Permanent | shall generate a Location header field containing a |
| | | | Redirect | URI pointing to the endpoint of another NF service |
| | | | | consumer to which the notification should be sent. |
| | | | | If an SCP redirects the message to another SCP |
| | | | | then the location header field shall contain the |
| | | | | same URI or a different URI pointing to the |
| | | | | endpoint of the NF service consumer to which the |
| | | | | notification should be sent. |

NOTE:
The mandatory HTTP error status code for the POST method listed in Table 5.2.7.1-1 of 3GPP TS 29.500 [4] also apply, with response body containing an object of ProblemDetails data type (see clause 5.2.7 of 3GPP TS 29.500 [4]).

TABLE 6.1.5.6.3.1-3
Headers supported by the 307 Response Code on this resource

| | Data | | | |
|---|---|---|---|---|
| Name | type | P | Cardinality | Description |
| Location | string | M | 1 | A URI pointing to the endpoint of |
| | | | | the NF service consumer to which |
| | | | | the notification should be sent |
| 3gpp-Sbi- | string | O | 0 . . . 1 | Identifier of the target NF (service) |
| Target- | | | | instance ID towards which the |
| Nf-Id | | | | request is redirected |

TABLE 6.1.5.6.3.1-4
Headers supported by the 308 Response Code on this resource

| | Data | | | |
|---|---|---|---|---|
| Name | type | P | Cardinality | Description |
| Location | string | M | 1 | A URI pointing to the endpoint of |
| | | | | the NF service consumer to which |
| | | | | the notification should be sent |
| 3gpp-Sbi- | string | 0 | 0 . . . 1 | Identifier of the target NF (service) |
| Target- | | | | instance ID towards which the |
| Nf-Id | | | | request is redirected |

***4th Change***(the Underline Indicates the Content to be Added to the 3GPP Technical Specification)

### 6.1.6.2.30 Type: N1N2MsgTxfrFailureNotification

TABLE 6.1.6.2.30-1
Definition of type NIN2MsgTxfrFailureNotification

| Attribute name | Data type | P | Cardinality | Description |
|---|---|---|---|---|
| Cause | N1N2MessageTrans- | M | 1 | This IE shall provide the result of the N1/N2 |
| | ferCause | | | message transfer at the AMF. |
| n1n2MsgDataUri | Uri | M | 1 | This IE shall contain the N1N2MessageTransfer |
| | | | | request resource URI returned in the Location |
| | | | | header when the N1/N2 message transfer was |
| | | | | initiated (see clause 6.1.3.5.3.1). |
| | | | | This IE shall be used by the NF Service Consumer |
| | | | | to correlate the notification with the UE or session for |
| | | | | which the earlier N1/N2 message transfer was |
| | | | | initiated. |
| | | | | If no Location header was returned when the N1/N2 |
| | | | | message transfer was initiated, e.g. when a 200 OK |
| | | | | response was sent for a UE in RRC inactive state, |
| | | | | this IE shall be set to a dummy URI, i.e. an URI with |
| | | | | no authority and an empty path (e.g. “http:”). |
| retryAfter | Uinteger | O | 0 . . . 1 | This IE may be included if the AMF requests |
| | | | | the NF Service Consumer to throttle sending |
| | | | | further N1/N2 messages for a short period, |
| | | | | e.g. when UE is not responding to paging. |
| | | | | When present, this IE indicates the throttle |
| | | | | period in seconds. The NF consumer should |
| | | | | throttle sending subsequent N1/N2 messages |
| | | | | during the period. |

### **5th Change***(the Underline Indicates the Content to be Added to the 3GPP Technical Specification)

### 6.1.7.3 Application Errors

The common application errors defined in the Table 5.2.7.2-1 in 3GPP TS 29.500 [4] may also be used for the Namf_Communication service. The following application errors listed in Table6.1.7.3-1 are specific for the Namf_Communication service.

TABLE 6.1.7.3-1
Application errors

| | HTTP status | |
|---|---|---|
| Application Error | code | Description |
| NF_CONSUMER_REDIRECT_ONE_TXN | 307 Temporary | The request has been asked to be redirected |
| | Redirect | to a specified target. |
| HANDOVER_FAILURE | 403 | Creation of UE context or relocation in the |
| | Forbidden | target AMF failed during Handover procedure |
| | | causing a failure of handover. |
| INTEGRITY_CHECK_FAIL | 403 | Integrity check of the complete registration |
| | Forbidden | message included in the UE context transfer |
| | | request failed. |
| EBI_EXHAUSTED | 403 | Allocation of EPS Bearer ID failed due to |
| | Forbidden | exhaustion of EBI as the maximum number |
| | | of EBIs has already been allocated to the UE. |
| EBI_REJECTED_LOCAL_POLICY | 403 | Allocation of EPS Bearer ID failed due to |
| | Forbidden | local policy at the AMF as specified in clause |
| | | 4.11.1.4.1 of 3GPP TS 23.502 [3]. |
| EBI_REJECTED_NO_N26 | 403 | The allocation of EPS Bearer ID was rejected |
| | Forbidden | when the AMF is in a serving PLMN that |
| | | does not support 5GS-EPS interworking |
| | | procedures with N26 interface. |
| SUPI_OR_PEI_UNKNOWN | 403 | The SUPI or PEI included in the message is |
| | Forbidden | unknown. |
| UE_IN_NON_ALLOWED_AREA | 403 | UE is currently in a non-allowed area hence |
| | Forbidden | the N1/N2 message transfer cannot be |
| | | completed because the request is not |
| | | associated with a regulatory prioritized |
| | | service. |
| UNSPECIFIED | 403 | The request is rejected due to unspecified |
| | Forbidden | reasons. |
| SM_CONTEXT_RELOCATION_REQUIRED | 403 | The request is rejected because the SM |
| | Forbidden | Context should be relocated to another SMF, |
| | | e.g. when AMF detects that an I-SMF or |
| | | V-SMF insertion, change or removal is |
| | | needed, as specified in clause 4.23 of |
| | | 3GPP TS 23.502 [3]. |
| UE_WITHOUT_N1_LPP_SUPPORT | 403 | UE does not support LPP in N1 mode hence |
| | Forbidden | the N1 LPP message cannot be sent to the |
| | | UE. |
| INVALID_SM_CONTEXT | 403 | The request is rejected because the SM |
| | Forbidden | Context is invalid for the PDU session, i.e. |
| | | active SM Context for the PDU session (with |
| | | same PDU Session ID) has been created on |
| | | another SMF. |
| | | (NOTE) |
| CONTEXT_NOT_FOUND | 404 Not | The requested UE Context does not exist on |
| | Found | the AMF |
| HIGHER_PRIORITY_REQUEST_ONGOING | 409 | Paging triggered N1/N2 transfer cannot be |
| | Conflict | initiated since already there is a paging due |
| | | to a higher priority session ongoing. |
| TEMPORARY_REJECT_REGISTRATION_ONGOING | 409 | N1/N2 message transfer towards UE/AN |
| | Conflict | cannot be initiated or the EBI assignment |
| | | fails due to an ongoing registration |
| | | procedure. |
| TEMPORARY_REJECT_HANDOVER_ONGOING | 409 | N1/N2 message transfer towards UE/AN |
| | Conflict | cannot be initiated due to an ongoing Xn or |
| | | N2 handover procedure, or the EBI |
| | | assignment fails due to an ongoing N2 |
| | | handover procedure or an ongoing Xn |
| | | handover procedure. |
| UE_IN_CM_IDLE_STATE | 409 | N2 message transfer towards 5G-AN cannot |
| | Conflict | be initiated due to the UE being in CM-IDLE |
| | | state for the Access Network Type |
| | | associated to the PDU session. |
| MAX_ACTIVE_SESSIONS_EXCEEDED | 409 | If the RAT type is NB-IoT, and the UE |
| | Conflict | already has 2 PDU Sessions with active user |
| | | plane resources. |
| REJECTION_DUE_TO_PAGING_RESTRICTION | 409 | If Paging Restrictions information restricts the |
| | Conflict | N1N2MessageTransfer request from causing |
| | | paging as defined in 3GPP TS 23.501 [2] |
| | | clause 5.38.5. |
| UE_NOT_REACHABLE | 504 | The UE is not reachable for paging. |
| | Gateway | |
| | Timeout | |
| UE_NOT_RESPONDING | 504 | The UE is not responding for paging. |
| | Gateway | |
| | Timeout | |

(NOTE):
More than one SM Contexts may be present in the network for the same PDU Session ID, e.g. when the UE established a new PDU session with the same PDU Session ID and the AMF failed to release the old SM Context in the old SMF. In such a scenario, if the old SMF tries to send N1 and/or N2 Message to the RAN/UE, the AMF shall respond with this application error if the AMF identified that service operation is invoked by the SMF holding the old SM Context.

***6th Change***(the Underline Indicates the Content to be Added to the 3GPP Technical Specification)

### A.2 Namf_Communication API

### Openapi: 3.0.0

```
**********************Text Skipped for Clarity************************
  N1N2MsgTxfrFailureNotification:
      description: Data within a N1/N2 Message Transfer Failure Notification request
      type: object
      properties:
        cause:
          $ref: ‘#/components/schemas/N1N2MessageTransferCause’
        n1n2MsgDataUri:
          $ref: ‘TS29571_CommonData.yaml#/components/schemas/Uri’
        retryAfter:
          $ref: ‘TS29571_CommonData.yaml#/components/schemas/Uinteger’
    required:
        - cause
        - n1n2MsgDataUri
**********************Text Skipped for Clarity************************
*** End of Changes ***
```

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuitries. These computer program instructions may be provided to a processor circuitry of a general purpose computer circuitry, special purpose computer circuitry, and/or other programmable data processing circuitry to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

### ABBREVIATIONS

3GPP 3rd Generation Partnership Project
5G fifth generation of mobile communication technology
AF Application Function
AMF Access and Mobility Management Function
DDN Downlink Data Notification
HTTP Hyper Text Transfer Protocol
LMF Location Management Function
NF Network Function
OTT Over The Top
PCC Policy and Charging Control
PCF Policy Control Function
PDU Packet Data Unit
RAN Radio Access Network
SMF Session Management Function
SMSF Short Message Service Function
UDM Unified Data Management
UE User Equipment.
UPF User Plane Function
URI Uniform Resource Identifier.

1. A method performed by a first network function implementing an Access and Mobility Management Function (AMF), comprising:
paging a User Equipment (UE); and
transmitting, to a second network function implementing a network function consumer, a failure notification message including a first parameter indicating a retry-after time, in response to a failure in the paging; wherein a transfer of message from the second network function to the first network function is suppressed during the retry-after time.

2. The method according to claim 1, wherein the failure notification message further includes a second parameter indicating a failure cause; and
wherein the failure cause is that the UE is not reachable or there is an ongoing procedure.

3. The method according to claim 1, wherein N1N2 message transfer request message is suppressed during the retry-after time; or
wherein the ongoing procedure is an ongoing registration procedure or an ongoing handover procedure.

4. The method according to claim 1,
wherein the failure notification message is N1N2 message transfer failure notification message; or
wherein the second network function implements a Session Management Function (SMF), Short Message Service Function (SMSF), Location Management Function (LMF), Policy Control Function (PCF), Gateway Mobile Location Center (GMLC), Network Exposure Function (NEF) or Unified Data Management (UDM).

5. A method performed by a second network function implementing a network function consumer, comprising:
receiving, from a first network function implementing an Access and Mobility Management Function (AMF), a failure notification message including a first parameter indicating a retry-after time, wherein the failure notification message is transmitted in response to a failure in a paging from the first network function to a User Equipment (UE); and
starting a retry-after timer, to suppress a transfer of message from the second network function to the first network function during the retry-after time.

6. The method according to claim 5, wherein the failure notification message further includes a second parameter indicating a failure cause; and
wherein the failure cause is that the UE is not reachable or there is an ongoing procedure.

7. The method according to claim 5, wherein N1N2 message transfer request message is suppressed during the retry-after time; or
wherein the ongoing procedure is an ongoing registration procedure or an ongoing handover procedure.

8. The method according to claim 5,
wherein the failure notification message is N1N2 message transfer failure notification message; or
wherein the second network function implements a Session Management Function (SMF), Short Message Service Function (SMSF), Location Management Function (LMF), Policy Control Function (PCF), Gateway Mobile Location Center (GMLC), Network Exposure Function (NEF) or Unified Data Management (UDM).

9. The method according to claim 5, further comprising:
receiving a data transfer request from a third network function implementing a User Plane Function (UPF);
buffering the data transfer request during the retry-after time; and
handling the data transfer request after the retry-after time.

10. The method according to claim 5, further comprising:
receiving a data transfer request from a third network function implementing a User Plane Function (UPF);
stopping a transfer of message to the first network function; and
informing the third network function to drop a buffer.

11. The method according to claim 9, wherein the data transfer request is a Downlink Data Notification (DDN) request.

12. The method according to claim 5, further comprising:
receiving a control plane request from a fourth network function implementing a Policy Control Function (PCF);
buffering the control plane request during the retry-after time; and
handling the control plane request after the retry-after time.

13. The method according to claim 5, further comprising:
receiving a control plane request from a fourth network function implementing a Policy Control Function (PCF);
stopping handling the control plane request; and
transmitting, to the fourth network function, an enforcement failure message.

14. The method according to claim 13, wherein the enforcement failure message further includes at least one of a third parameter indicating a failure code and a fourth parameter indicating a rule status.

15. The method according to claim 13, wherein the control plane request is a session management policy control update notify request or a session management policy control update response.

16. The method according to claim 15, wherein the session management policy is a Policy and Charging Control (PCC) rule.

17. A first network function implementing an Access and Mobility Management Function (AMF), comprising:
at least one processor; and
a non-transitory computer readable medium coupled to the at least one processor, the non-transitory computer readable medium contains instructions executable by the at least one processor, whereby the at least one processor is configured to;
page a User Equipment (UE); and
transmit, to a second network function implementing a network function consumer, a failure notification message including a first parameter indicating a retry-after time, in response to a failure in the paging; wherein a transfer of message from the second network function to the first network function is suppressed during the retry-after time.

18. A second network function implementing a network function consumer, comprising:
at least one processor; and
a non-transitory computer readable medium coupled to the at least one processor, the non-transitory computer readable medium contains instructions executable by the at least one processor, whereby the at least one processor is configured to;
receive, from a first network function implementing an Access and Mobility Management Function (AMF, a failure notification message including a first parameter indicating a retry-after time, wherein the failure notification message is transmitted in response to a failure in a paging from the first network function to a User Equipment (UE); and
start a retry-after timer, to suppress a transfer of message from the second network function to the first network function during the retry-after time.

19-20. (canceled)

21. The method according to claim 10, wherein the data transfer request is a Downlink Data Notification (DDN) request.

22. The second network function according to claim 18, the at least one processor is further configured to:
receive a data transfer request from a third network function implementing a User Plane Function (UPF);
buffer the data transfer request during the retry-after time; and
handle the data transfer request after the retry-after time.
